(19) United States
(12) Patent Application Publication
(10) Pub. No.: US 2018/0079126 A1
(43) Pub. Date: Mar. 22, 2018

(54) INDEPENDENTLY DRIVEN DEVICE FOR USE WITH PLASTIC MELT FEED SCREW

(71) Applicants: Robert A. Barr, Bondurant, WY (US); Jeffrey A. Myers, Onsted, MI (US)

(72) Inventors: Robert A. Barr, Bondurant, WY (US); Jeffrey A. Myers, Onsted, MI (US)

(21) Appl. No.: 15/272,461

(22) Filed: Sep. 22, 2016

(51) Int. Cl. B29C 47/64; B29B 7/14; B29C 47/76

(52) U.S. Cl. CPC B29C 47/64; B29C 47/767; B29B 7/14

(57) ABSTRACT

A plastic melt machine includes a feed screw rotatably mounted in a barrel and driven in rotation about a longitudinal screw axis of the feed screw by a screw drive to plasticize material, and an apparatus for driving a device independently of the feed screw. The device can be any rotatable device associated with the feed screw wherein the device is rotatable about a drive axis and is in fluid communication with the barrel to receive the plasticized material. The drive axis is coaxial with the screw axis. A drive shaft couples the device to the device drive, or to the screw drive through a speed changer, for rotating the device independently of the rotation of the feed screw by the screw drive.

### FIELD OF THE INVENTION

This invention relates to an apparatus positioned at the downstream end of the power driven feed screw in a plastic melt machine or apparatus.

### BACKGROUND OF THE INVENTION

This section provides background information related to the present disclosure which is not necessarily prior art.

A wide variety of apparatuses have been proposed for the fluxing and mixing of thermoplastic materials. The essential requirements for such apparatus include rapid fluxing or melting of the material and efficient mixing of the material components into a homogeneous blend, both at an effectively high throughput rate. Whereas some prior apparatuses are capable of satisfying the desired fluxing and mixing requirements, they are incapable of delivering the necessary throughput rate. Other prior apparatuses sacrifice fluxing and/or mixing efficiency in order to provide the required throughput rate.

There are several different plastic melt mixing devices that can be attached to the feed screw for the mixing of thermoplastic materials with high fluxing and mixing efficiency and are capable of delivering a high material throughput rate. Dispersive mixing applies force to the materials and thus requires drive energy that ends up in the polymer mix to help melt it and/or raise its temperature. Consequently, dispersive mixing assists or adds to the melting capacity of the screw. In addition, tight clearances often function as a “dam,” restricting unmelted polymer from passing through until reduced in size or melted. Many feed screw designs would discharge unmelted polymer at almost all speeds without a dispersive mixer. The “Maddock” mixer is an example of a mixer that is primarily dispersive, with lesser distributive characteristics.

The U.S. Pat. No. 3,730,492 describes the “Maddock” mixing head. An extruder heats thermoplastic material to a flowable condition, longitudinally advancing the heated material under pressure toward the discharge end with a rotating extrusion feed screw having the Maddock mixer head at the downstream end thereof. The mixer head divides the heated material into a plurality of streams and passes the streams through a plurality of longitudinal mixing passages thereby passing the plurality of individual streams of the partially fluxed melt through high shear zones between the mixer head and the barrel of the extruder, and then passes the fluxed melt into the interior of the mixer head and therethrough to the discharge end of the mixer head. In summary, the Maddock mixer passes melt over a very narrow clearance where it experiences high shear for a high degree of dispersive mixing. The melt is divided several times and reoriented to provide some distributive mixing.

Although distributive mixing also requires some drive power, it is generally small enough to have a very minor effect on the melt temperature. A “Saxton” style mixer is an example of a mixer that is mostly distributive with minor dispersive characteristics. In the Saxton mixer, melt is divided many times and recombined with numerous reorientations to provide mostly distributive mixing.

An “Eagan” style mixer combines strong dispersive and distributive characteristics. All of the flights are undercut so there is a lot more dispersive and distributive mixing than with the Maddock mixing section. In the Egan mixer, a reduced diameter provides multiple high-shear regions as well as leakage flow and many reorientations for high levels of both dispersive and distributive mixing.

U.S. Pat. No. 4,779,989, issued to Robert A. Barr, describes a mixer assembly for mixing fluid material in the bore of a barrel including a structure for mixing and pumping toward its outlet end the material fed thereto. A stator assembly is fixed in the barrel having outer cylindrical surface portions conforming substantially to the surface of the bore and having a stator bore provided with a groove-interrupted inner surface, and a driven rotor member has a groove-interrupted outer surface confronting the inner stator surface. The inner stator surface and outer rotor surface each have continuous helical grooves cut therein along a helical path which changes in depth with length from a small minimum depth to a larger maximum depth but never disappearing and having a plurality of axially spaced circumferential grooves at planes perpendicular to the bore center axis subdividing such surfaces into axially spaced serially arranged mixer sections with portions of the helical grooves extending between the circumferential grooves defining each section.

U.S. Pat. No. 5,988,866, issued to Robert A. Barr, describes a mixer for plasticable resins having a fixedly positioned heated barrel with a power driven feed screw mounted axially in the barrel bore, and a driven rotor axially aligned with and extending in a downstream direction from the downstream end of power driven screw. A series of elongated rotor flow transfer cavities are in the outer surface of the rotor. The rotor flow transfer cavities extending inwardly and are arranged in a plurality of axially aligned rows and a plurality of annular rows concentric to the axis of the rotor. A floating sleeve is coaxially positioned over the power driven rotor and interposed between the rotor and the barrel so as to be capable of independent rotation relative to both the power driven rotor and the barrel. The floating sleeve has a plurality of parallel outwardly extending ring flanges extending radially outwardly and inwardly facing a plurality of annular and elongated in cross-section outer sleeve flow channels each having an upstream end and a downstream end provided between adjacent ring flanges. A series of outflow apertures extend through the floating sleeve and communicate on opposite ends with the upstream end of an elongated outer sleeve flow channel of the floating sleeve flow channel and the downstream end of one of the elongated rotor flow transfer cavities of the rotor.

U.S. Pat. No. 6,254,266, issued to Robert A. Barr and Jeffrey A. Myers, describes an extruder-mixer having a plurality of rotor rings provided on the downstream end of a motor driven feed screw shaft mounted for rotation in a conventional heated barrel or stator. The rings comprise a plurality of spaced driven rotor rings spaced apart from each other and a plurality of non-driven but rotatable floating rings interleaved between each pair of driven rotor rings. Both rings have parallel upstream and downstream faces between which polymer flow passageways extend so that the polymer melt moves downstream first through one type of ring followed by movement through the other type of ring and the viscosity of the melt causes the rotatable floating rings to be rotated by the driven rings at a slower speed than the driven rings so that shearing force on the melt effects mixing of the melt.

The above-described plastic melt mixing devices all are attached to the feed screw for rotation. Since the rotational speed of the mixer attached to the screw is the same as the screw speed the mixing effect cannot be changed without a redesigned mixing head. This can be a problem, especially with large extruders wherein the screw rotational velocity (i.e. RPM) is relatively low compared to smaller diameter screws. This leads to less of a mixing effect. To provide for an adjustable mixing effect with a given design mixer it would be desirable to have the mixer rotational velocity (RPM) adjustable independent of the extruder screw.

In addition to mixing devices, it would be beneficial to drive other devices independently of the feed screw. Such devices can include, for example, vent sections, injection port sections, melting sections and temperature gradient reduction sections.

### BRIEF SUMMARY OF THE INVENTION

The purpose of this invention is to provide an apparatus having a device that is rotated independently from the feed screw. In concordance with the instant disclosure, this purpose is accomplished by driving the device so that the rotational speed of the device can be changed independently of the feed screw rotational speed.

According to the invention, the device is mounted at the output end of the feed screw and is driven by a drive shaft thru a bore in the feed screw. In the following, this configuration is referred to as a “coaxial drive”.

An apparatus for driving a device of a plastic melt machine independently of a feed screw is used with the feed screw being rotatably mounted in a barrel and driven in rotation about a longitudinal screw axis of the feed screw by a screw drive to plasticize material. The apparatus includes the device being rotatable about a drive axis, the apparatus being in fluid communication with the barrel to receive the plasticized material, and a device drive coupled to the device for rotating the device independently of the rotation of the feed screw by the screw drive. The device can be a mixing device, a screw vent section, or any other device typically used with a feed screw.

The device can be rotated by the device drive about a device axis that coincides with the screw axis. The feed screw has a bore formed therein rotatably receiving a drive shaft coupling the device to the device drive.

The device drive can include an electric motor coupled to the device. The device drive can further include a driving pulley rotated by the electric motor, a driven pulley coupled to the device by a drive shaft and an endless belt coupling the driving pulley to the driven pulley.

The device drive can be a speed changer driven by the feed screw drive and driving the device draft shaft.

The coaxial drive device according to the invention can be utilized in a vented application to control the degree of devolatilization. The coaxial drive device also can be used in a foaming application for a single primary and secondary feed screw combined into one. These feed screws typically are 50-60 LD. An advantage is that a coaxial cooling screw section can be run at lower speeds to reduce shear and increase cooling.

### BRIEF DESCRIPTION OF THE SEVERAL VIEWS OF THE DRAWING

The above as well as other advantages of the invention will become readily apparent to those skilled in the art from the following detailed description of a preferred embodiment when considered in the light of the accompanying drawings in which:

FIG. 1 is a side elevation view of the discharge end portion of the screw section of a single screw extruder assembly according to the prior art having a mixing device connected to the end of the feed screw with the barrel of the extruder assembly being shown in section;

FIG. 2 is a side elevation view of the prior art mixing device rotor shown in FIG. 1;

FIG. 3 is a side elevation cross-sectional view of a single screw extruder assembly according to the invention having an independently driven mixing apparatus attached to the end of the barrel and driven by a drive shaft extending through the feed screw;

FIG. 4 is a side elevation cross-sectional view of the single screw extruder assembly shown in FIG. 3 modified according to the invention by replacing the mixing apparatus with a vent section; and

FIG. 5 is a block diagram of an alternate embodiment independent drive for the drive shaft according to the invention.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

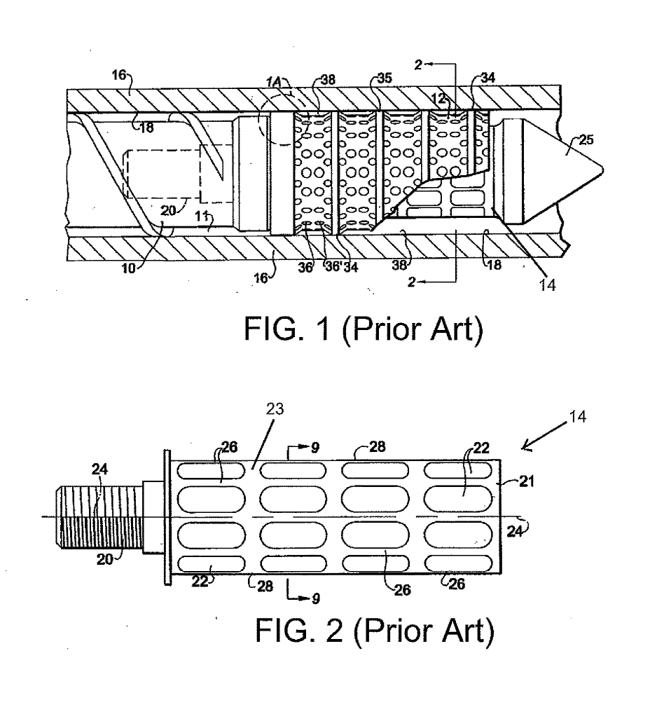

Reference is made to FIG. 1, corresponding to FIG. 1 of U.S. Pat. No. 5,988,866, showing a conventional extruder feed screw 10 and FIG. 2, corresponding to FIG. 8 of U.S. Pat. No. 5,988,866, showing a rotor 14 of a mixing device attached to the feed screw 10. The mixing device includes a floating sleeve 12 coaxially positioned relative to the feed screw 10 and the rotor 14 fixedly mounted on and attached to the downstream end of the feed screw 10. The floating sleeve 12 surrounds and is coaxial with an axis 24 of rotor 14 which is coextensive with an axis of the feed screw 10. The floating sleeve 12 is free to rotate about the axis 24 of the rotor 14. Also, the sleeve 12 and the rotor 14 are capable of limited axial movement relative to each other. The aforementioned components are mounted in a conventional cylindrical barrel 16 that is heated by conventional means (not shown) and which includes an inwardly facing cylindrical surface 18 as shown in FIG. 1.

The rotor 14 has a stub member including a mounting stub 20 received in an axial aperture in the downstream end of the feed screw 10 as shown in FIG. 1. A cylindrical body portion 21 is unitarily formed with the mounting stub 20 and includes an outer surface 23 provided with a plurality of elongated rotor flow transfer cavities 22 arranged in a series of annular rows about the periphery of the rotor. Each annular row of rotor flow transfer cavities 22 is concentric with respect to the axis 24 of the rotor 14 which is itself coextensive with the axis of the feed screw 10. Additionally, the elongated rotor flow recesses 22 are arranged in axially parallel linear rows that are parallel to the axis 24 as shown in FIG. 2. The axially parallel linear rows of the rotor flow recesses 22 are separated by linear ribs 26 extending parallel to the axis 24. Similarly, the annular rows extend about the periphery of the rotor 14 in a concentric manner with respect to the axis 24 and are separated by annular rotor rings 28 as shown in FIG. 2. A removable tip 25 is axially received and threaded into the downstream end of the rotor 14 as shown in FIG. 1.

Since the rotor 14 is attached to the downstream end of the feed screw 10, the rotor 14 and the screw 10 will rotate at the same speed. Thus, the mixing effect of the mixing device cannot be changed without a redesigned mixing head. This can be a problem, especially with large extruders wherein the screw rotational velocity (i.e. RPM) is relatively low compared to smaller diameter screws. This leads to less of a mixing effect. To provide for an adjustable mixing effect with a given design mixer the invention described below provides a mixer rotational velocity (RPM) that is adjustable independently of the feed screw rotational velocity.

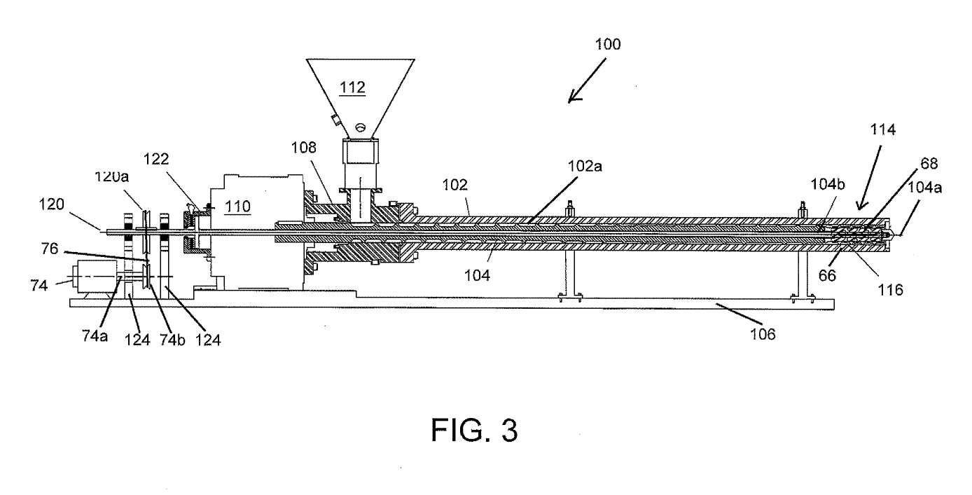

FIG. 3 is a side elevation cross-sectional view of a single screw extruder assembly 100 according to the invention having a “coaxial drive” mixing apparatus. In this embodiment of the invention, the mixing device is driven by a drive shaft extending through the feed screw. The assembly 100 includes a hollow barrel 102 having a bore 102a in which a feed screw 104 is rotatably mounted for rotation about a longitudinal axis 104a. The barrel 102 is mounted on a base 106 and has an inlet end attached to a feed throat 108. The screw 104 extends through a hollow interior of the feed throat 108 and is coupled to a screw drive 110 that can be a combination drive motor and gear box. A hopper 112 is attached to the feed throat 108 for supplying unmelted plastic material to the interior of the feed throat.

A “coaxial drive” mixing apparatus 114 is mounted at an outlet end of the barrel 102. The mixing apparatus 114 includes an outlet end portion 116 of the barrel 102. The barrel bore 102a extends through the portion 116. The portion 116 receives a mixing device that can be a FLUXION™ mixer available from Robert Barr, Inc. of Virginia Beach, Va. and Onsted, Mich. However, other devices can be used. The mixing device includes a stator 66 mounted in the portion 116 and a rotor 68 rotatably positioned inside the hollow stator 66. The rotor 68 is attached an axially extending drive shaft 120 that extends through a central bore 104b of the feed screw 104 coaxial with the axis 104a.

The drive shaft 120 extends through or adjacent to the drive 110 and is rotatably supported by a thrust bearing housing 122 at the drive 110 and a pair of support bearings 124 mounted on the base 106. A driven pulley 120a is attached to the drive shaft 120. The device drive motor 74 is mounted on the base 106 and has the output shaft 74a on which is mounted the driving pulley 74b. The pulleys 120a and 74b are connected by the endless belt 76. When the device drive motor 74 is actuated, the driving pulley 74b is rotated and, through the belt 76, rotates the driven pulley 120a. Rotation of the pulley 120a causes the drive shaft 120 and the rotor 68 to rotate thereby mixing any plastic material in the portion 116. The rotor 68 rotates about a device axis of rotation that coincides with the screw axis 104a. Since the feed screw 104 is rotated by the separate screw drive 110, the rotational speed of the mixing device rotor 68 can be controlled independently of the rotational speed of the feed screw 104.

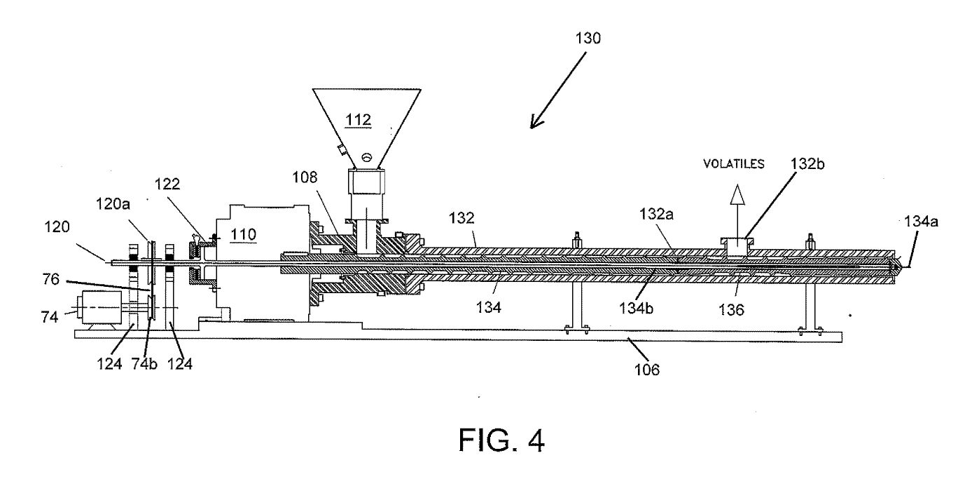

FIG. 4 shows the single screw extruder assembly of FIG. 3 modified according to the invention by replacing the “coaxial drive” mixing apparatus 114 with a “coaxial drive” apparatus configured as a vent section. The modified extruder assembly 130 differs from the extruder assembly 100 in that a barrel 132 with a bore 132a has a vent port 132b formed in the barrel wall near the outlet end. The vent port 132b permits accumulated volatiles generated during plasticizing of the material to escape from the barrel 132 prior to the melted plastic material being extruded from the outlet end of the barrel. A feed screw 134 replaces the feed screw 104. The screw 134 is mounted in the bore 132a and is rotated about a longitudinal axis 134a by the screw drive 110.

The screw 134 has an axial bore 134b that receives the drive shaft 120. A rotatable device in the form of a screw vent section 136 is attached at an output end of the drive shaft 120 that extends beyond the end of the screw 134. The vent section 136 is positioned adjacent to the vent port 132b. As with the mixing device shown in FIG. 3, the vent section 136 is rotated by the device drive motor 74. The vent section 136 rotates about a device axis of rotation that coincides with the screw axis 104a. Since the feed screw 134 is rotated by the separate screw drive 110, the rotational speed of the vent section 136 can be controlled independently of the rotational speed of the feed screw 134.

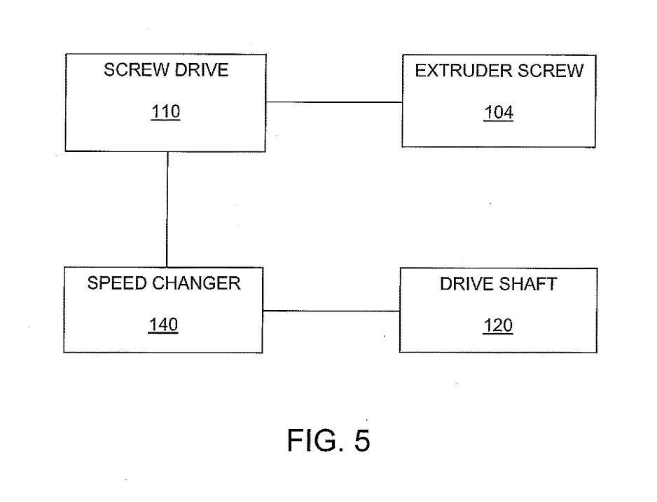

The device drive components 74, 74a, 74b, 120a and 124 can be replaced by a device drive that is rotated by the screw drive 110 directly or indirectly. As shown in FIG. 5, a conventional speed changer 140 has an input coupled to the screw drive 110 either directly to a motor shaft or indirectly through gears. An output of the speed changer 140 is coupled to the drive shaft 120. The speed changer 140 can be operated to rotate the drive shaft at a selected speed that is less than equal to or greater than the speed at which the feed screw 104 is being rotated by the screw drive 110.

Although the mixing apparatus 114 and the screw vent section 136 are shown and described as examples of independently driven devices according to the invention, other devices associated with plastic melting machines can be similarly driven. Such devices can include, without limitation, injection port sections, melting sections and temperature gradient reduction sections.

In accordance with the provisions of the patent statutes, the invention has been described in what is considered to represent its preferred embodiment. However, it should be noted that the invention can be practiced otherwise than as specifically illustrated and described without departing from its spirit or scope.

1. An apparatus for use in a plastic melt machine, the plastic melt machine including a feed screw rotatably mounted in a barrel and driven in rotation about a longitudinal screw axis of the feed screw by a screw drive to plasticize material, the apparatus comprising:
a device rotatable about a drive axis coaxial with the screw axis, the device being rotatably mounted in the barrel to receive material plasticized by rotation of the feed screw; and
a device drive coupled to the device for rotating the device independently of the rotation of the feed screw by the screw drive.

2. The apparatus according to claim 1 wherein the device is a mixing device.

3. The apparatus according to claim 1 wherein the device is one of a screw vent section, a mixing section, an injection port section, a melting section and a temperature gradient reduction section.

4. The apparatus according to claim 1 wherein the feed screw has a bore formed therein rotatably receiving a drive shaft coupling the device to the device drive.

5. The apparatus according to claim 1 wherein the device drive includes an electric motor coupled to the device.

6. The apparatus according to claim 5 wherein the device drive includes a driving pulley rotated by the electric motor, a driven pulley coupled to the device by a drive shaft and an endless belt coupling the driving pulley to the driven pulley.

7. The apparatus according to claim 1 wherein the device drive includes a speed changer coupled between the screw drive and the device.

8. The apparatus according to claim 7 including a drive shaft coupling the device to the speed changer.

9. An apparatus for use in a plastic melt machine, the plastic melt machine including a feed screw rotatably mounted in a barrel and driven in rotation about a longitudinal screw axis of the feed screw by a screw drive to plasticize material, the apparatus comprising:
a device rotatable about a drive axis coaxial with the screw axis, the device being rotatably mounted in the barrel to receive material plasticized by rotation of the feed screw;
a drive shaft coupled to the device; and
a device drive coupled to the drive shaft for rotating the device independently of the rotation of the feed screw by the screw drive.

10. The apparatus according to claim 9 wherein the device is one of a mixing device, a screw vent section, an injection port section, a melting section and a temperature gradient reduction section.

11. The apparatus according to claim 9 wherein the feed screw has a bore formed therein rotatably receiving the drive shaft coupling the device to the device drive.

12. The apparatus according to claim 9 wherein the device drive includes an electric motor coupled to the drive shaft.

13. The apparatus according to claim 12 wherein the device drive includes a driving pulley rotated by the electric motor, a driven pulley coupled to the device by the drive shaft and an endless belt coupling the driving pulley to the driven pulley.

14. The apparatus according to claim 9 wherein the device drive includes a speed changer coupled between the screw drive and the drive shaft.

15. An apparatus for use in a plastic melt machine, the plastic melt machine including a feed screw rotatably mounted in a barrel and driven in rotation about a longitudinal screw axis of the feed screw by a screw drive to plasticize material, the apparatus comprising:
a device rotatable about a drive axis coaxial with the screw axis, the device being mounted in the barrel to receive material plasticized by rotation of the feed screw;
a drive shaft coupled to the device and extending through a longitudinal bore formed in the feed screw; and
a device drive coupled to the drive shaft for rotating the device independently of the rotation of the feed screw by the screw drive.

16. The apparatus according to claim 15 wherein the device is one of a mixing device, a screw vent section, a melting section, an injection port and a temperature gradient reduction section.

17. The apparatus according to claim 15 wherein the device drive is positioned adjacent an inlet end of the barrel.

18. The apparatus according to claim 15 wherein the device drive includes an electric motor coupled to the drive shaft.

19. The apparatus according to claim 18 wherein the device drive includes a driving pulley rotated by the electric motor, a driven pulley coupled to the device by the drive shaft and an endless belt coupling the driving pulley to the driven pulley.

20. The apparatus according to claim 15 wherein the device drive includes a speed changer coupled between the screw drive and the drive shaft.
